(19) United States
(12) Patent Application Publication
(10) Pub. No.: US 2003/0055699 A1
(43) Pub. Date: Mar. 20, 2003

(54) Employee development management method and system

(76) Inventor: Joseph J. O'Connor, Bloomfield Hills, MI (US)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(21) Appl. No.: 10/235,297

(22) Filed: Sep. 5, 2002

Related U.S. Application Data
(60) Provisional application No. 60/322,917, filed on Sep. 18, 2001.
(60) Provisional application No. 60/337,519, filed on Dec. 3, 2001.

(51) Int. Cl. G06F 17/60

(52) U.S. Cl. 705/7

(57) ABSTRACT

A computer based system and method manages and tracks development of employees for an organization. Development and government requirements data relating to the development of the employees is stored in a database. The system and method provide access to the data to the employees and allow an employee to manage an employee development plan as a function of the data and sign up for courses to meet the government requirements. The system is also adapted to verify completion of a course by the employee and to responsively update the employee development data.

This application claims the benefit of U.S. Provisional Application No. 60/322,917, filed Sep. 18, 2001 and U.S. Provisional Application No. 60/337,519, filed Dec. 3, 2001.

### FIELD OF THE INVENTION

The present invention relates generally to the development of employees, and more particularly, to a system and method for managing the development of the employees of organizations.

### BACKGROUND OF THE INVENTION

Organizations and their employees, such as businesses and educational organizations, as industries are becoming subjected to increasing regulations. For example, professionals, such as medical professionals and teachers, are often regulated by federal, state and local laws. Other employees may also be regulated regarding their training on such subjects as sexual harassment and hazardous materials.

Often times it is the responsibility of the organization to provide such training, but left to the individual to be aware of the requirements, sign up for courses or other training that meets the requirements, and generally, to track their own progress on meeting the requirements. The requirements for a particular individual based on their jib category, their progress, and plan for meeting these requirements are generally known as a development plan.

Historically, an individual must rely on the organization to provide the requirements and their progress on meeting these requirements are generally accomplished using paper files. This is not an efficient process. Nor is the process sufficient to ensure that all employees are aware of their requirements or are aware of the courses available to meet their requirements. Furthermore, it is difficult for the organization to ensure that it is complying with the regulations.

The present invention is aimed at one or more of the problems identified above.

### SUMMARY OF THE INVENTION

In one aspect of the present invention, a computer based system for managing and tracking development of employees of an organization, is provided. The system includes a database for storing employee development and government requirements data relating to the development of the employees and a first processing unit coupled to the database. The processing unit provides access to the data to the employees and allows an employee to manage an employee development plan as a function of the data and to sign up for courses to meet the government requirements.

In another aspect of the present invention, a computer based method for managing and tracking development of employees of an organization, is provided. The method includes the steps of storing employee development and government requirements data relating to the development of the employees in a database and providing access to the data to the employees. The method further includes the steps of allowing an employee to manage an employee development plan as a function of the employee development and the government requirements data and to sign up for courses to meet the government requirements and verifying completion of a course by the employee and for responsively updating the employee development data.

### BRIEF DESCRIPTION OF THE DRAWINGS

Other advantages of the present invention will be readily appreciated as the same becomes better understood by reference to the following detailed description when considered in connection with the accompanying drawings wherein:

FIG. 1 is a block diagram of a system for managing and tracking development of employees for an organization, according to an embodiment of the present invention;

FIG. 2 is a flow diagram of a method for managing and tracking development of employees for an organization, according to an embodiment of the present invention;

FIG. 3 is a diagrammatic illustration of a Logon screen, according to an embodiment of the present invention;

FIG. 4 is a diagrammatic illustration of a News Bulletin Board screen, according to an embodiment of the present invention;

FIG. 5 is a diagrammatic illustration of a Development Plan screen, according to an embodiment of the present invention;

FIG. 6 is a diagrammatic illustration of a Change Validation popup, according to an embodiment of the present invention;

FIG. 7 is a diagrammatic illustration of a Check Requirements panel, according to an embodiment of the present invention;

FIG. 8 is a diagrammatic illustration of a Available Courses panel, according to an embodiment of the present invention;

FIG. 9 is a diagrammatic illustration of an Available Courses drop down list, according to an embodiment of the present invention;

FIG. 10 is a second diagrammatic illustration of the Available Courses panel, according to an embodiment of the present invention;

FIG. 11 is a third diagrammatic illustration of the Available Courses panel, according to an embodiment of the present invention;

FIG. 12 is a diagrammatic illustration of an Available Courses—Calendar panel, according to an embodiment of the present invention;

FIG. 13 is a diagrammatic illustration of a Special Request panel, according to an embodiment of the present invention;

FIG. 14 is a diagrammatic illustration of a Reports panel, according to an embodiment of the present invention;

FIG. 15 is a diagrammatic illustration of an Administrative View screen, according to an embodiment of the present invention;

FIG. 16 is a diagrammatic illustration of a View/Edit panel, according to an embodiment of the present invention;

FIG. 17 is a diagrammatic illustration of a Course Requirements popup, according to an embodiment of the present invention; and,

FIG. 18 is a diagrammatic illustration of a proactive email communication, according to an embodiment of the present invention.

### DETAILED DESCRIPTION OF THE PREFERRED EMBODIMENT

With reference to the drawings and in operation, the present invention provides a computer based system for computer based system 10 for managing and tracking development of employees of an organization. One suitable organization is an education organization, such as a public school, a school district containing a plurality of schools, a state having a plurality of districts, or a multi-state organization each having one or more districts.

Each school has a plurality of employees. The employees of the school may be categorized according to their job functions, e.g., teachers, administrators (such as principals or human resource managers), and other staff employees, such as bus drivers, cafeteria workers, health workers etc . . . Each category may have different requirements. For example, teachers may have government requirements as new teachers and may have continuing education requirements to maintain licensure as a teacher. Other employees may have requirements related to providing medical assistance (such as CPR) or dealing with hazardous materials. As described below, the system 10 allows individual employees to view their requirements (based on their job classification), view their progress on meeting these requirements, and update and plan their Development Plan.

With reference to FIG. 1, the system includes a first computer system 12 located at a central location 14. The first computer system 12 includes a first processing unit 16 which is implemented in at least one first computer 18 and one or more computer program applications 20 running on the at least one first computer 18. A database 22, coupled, to the first computer system 12, stores employee development data (including individual development plans) and the government requirements data (including the requirements for each job classification or category). In one embodiment, the database 22 is a relational database and the computer program applications 20 include a database program.

In one embodiment, the system 10 may be accessed by users through the first computer system 12. Users may include employees accessing and updating their development plan, administrators updating information stored on the database 22 (such as available classes), and system managers managing the system 10 and/or database 22.

In another embodiment, the system 10 includes a second computer system 24 located at a remote location 26. The first and second computer system 12, 24 are coupled via a computer network 28, such as the internet. The second computer system 22 includes a second processing unit 30 which includes at least one second computer 32 and one or more computer program applications 34. The second computer system 24 provides access to the system 10 to employees 36 through a graphical user interface (GUI) 38. In one embodiment, the GUI 38 is implemented as a web page. The one or more computer program applications 34 includes a web browser, such as, Internet Explorer available from Microsoft Corporation of Redmond, Wash. for displaying the GUI 38.

In one embodiment, the second computer system 24 may include a printer 40 which reports to be printed. Alternatively, the printer 40 may be separate from the system 10 or connected to another computer on the network 28.

In a first embodiment of the present invention, the system 10 is a stand-alone system allowing employees to access and manipulate their own development plan. The first processing unit 12 provides access to the data to the employees, allows an individual employee to manage an employee development plan as a function of the data and to sign up for courses to meet the government requirements. The processing unit 12 verifies the completion of a course by the employee and for responsively updating the employee development data. A course may include a traditional type of course with instructor and student(s) in a class room, a web-based course, or any other type of instruction or event which meets the requirements, e.g., a mentoring session with a more experienced employee.

In a second embodiment of the present invention, the at least one first computer 18 is a file server which interacts with the at least one second computer 32. The first processing unit 12 accesses and manipulates the data stored in the database 22. The second processing unit 24, provides access to the system 10 to one or more users or employees 36.

In one embodiment of the present invention, the first processing unit 12 is adapted o provide news related to the organization or development plan to the employee. This may be done, for example, using a bulleting board news section (see below), which provides general interest news items to employees, such as meeting notices.

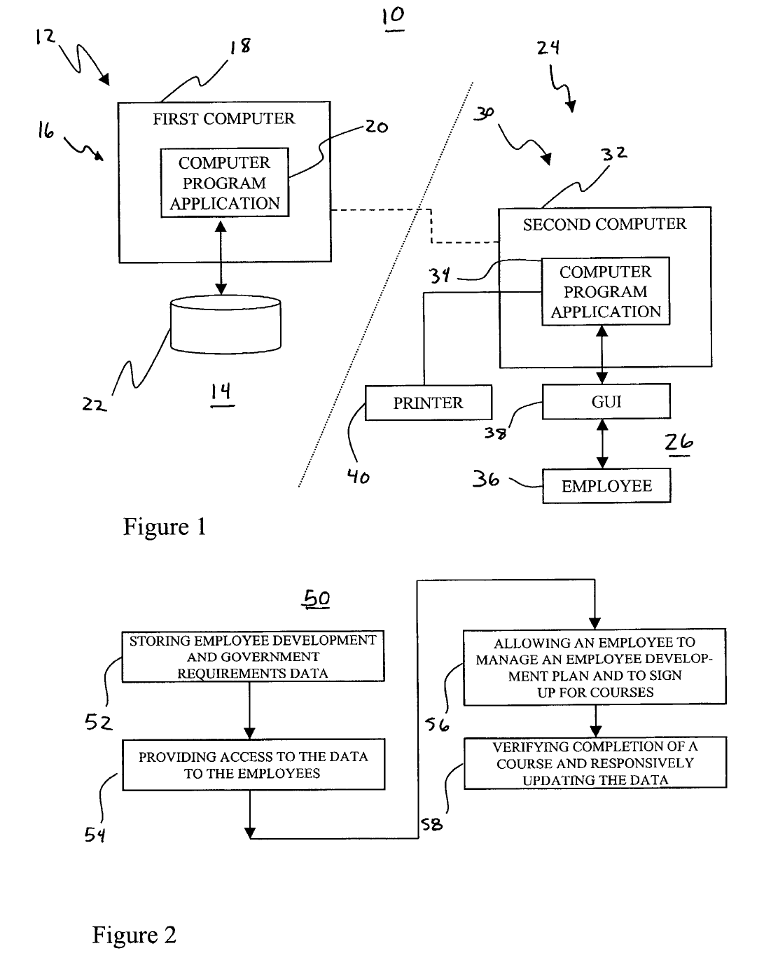

With reference to FIG. 2, in another aspect of the present invention, a method 50 for managing and tracking development of the development of employees of an organization, according to an embodiment of the present invention, is illustrated.

In a first process step 52, the method includes the step of storing employee development and government requirements data. In a second process step 54, access to the data is provided to the employees. An employee of the organization is allowed to manage an employee development plan and to sign up for courses to meet the requirements. In a fourth process step 54, completion of a course is verified and the data stored is updated.

In another aspect of the present invention, the system 10 and method 50 are adapted to send email communications to users. In one embodiment, the email communications are pro-active and timely with regard to a user's development plan. The email communications may be time sensitive and relative to specific issues. The communications may automatically alert individual users with respect to their individual status, at any given time, in relation to their individual requirements as set forth by supervisor, local district, or a governing regulatory agency. For example, an email communication may include a confirmation of registration, cancellation or completion of course or requirement. In another example, an email communication may be sent at predetermined times (of the year or relative some other event) as a reminder to users to update their development plans. Additional email communication may be related, but are not limited to, course notifications, requests to update professional development plan, status of special requests, and special requests in queue.

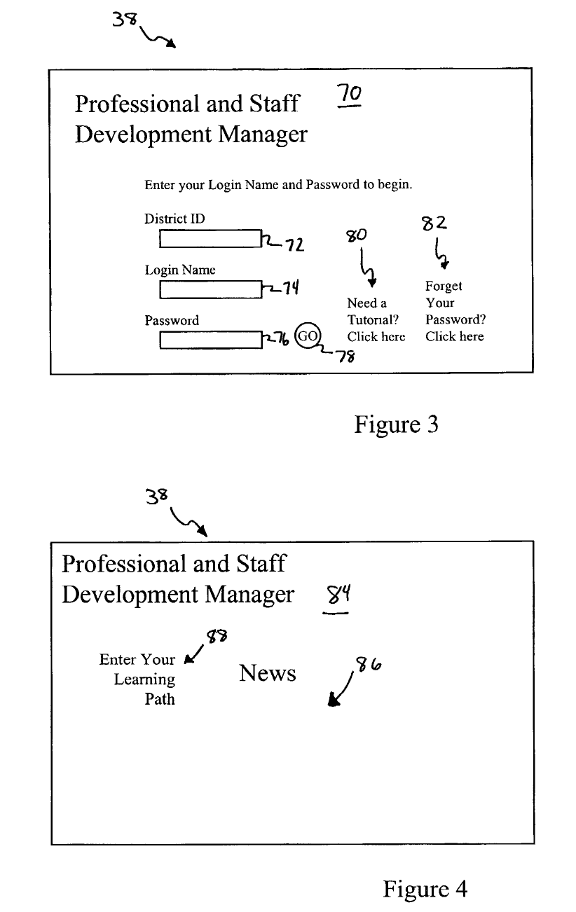

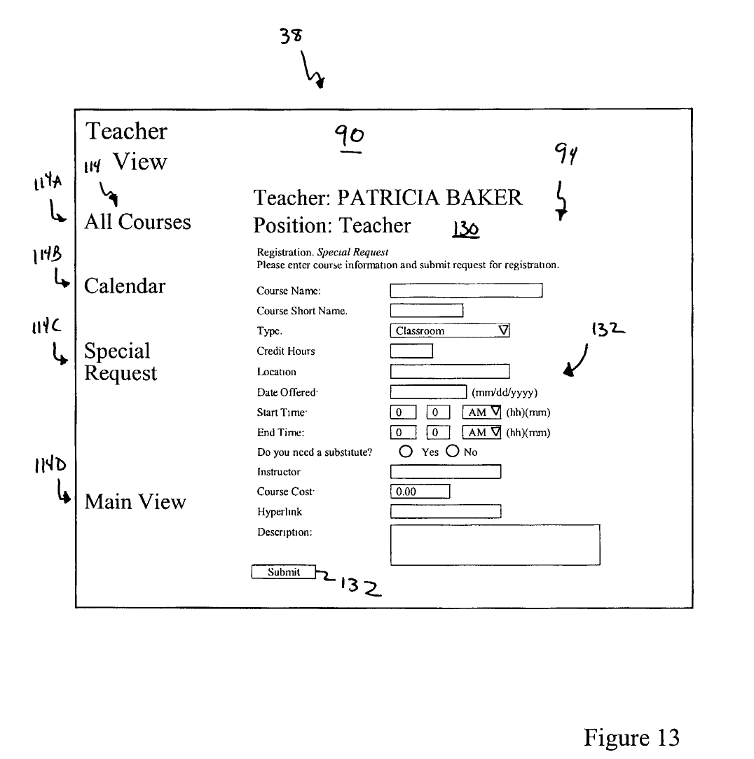

With reference to FIGS. 3-18, in one embodiment the system 10 is adapted to provide access to and manage the individual development plans of at least one employee of an education organization, e.g., a school, school district, state, or multi-state region. The at least one employee may be a teacher, administrator (such as a principal or human resource manager), or a staff employee, such as a bus driver, a cafeteria worker, health worker, and/or other employee, etc.. Each type or category of employee may have different requirements, and this, their development plan may be tailored to meet such requirements. In one aspect of the present invention, the first computer system 12 includes one or more first computers 18, which act as servers for the second computer system 24, and are located at the central location 14.

The system 10 is accessed by one or more second computers 32 which may be located at one or more locations remote 26 from the central location 14. In one embodiment the second computers 32 are coupled to the first computer system 12 via the internet. The system 10 is accessed by employees 36 of the organization via a web-based GUI 38. The web-based GUI 38 may be accessible through any computer connected to the internet, including, but not limited to, schools located at a facility owned or operated by the organization, computers located at public locations, and/or home computers.

With reference to FIGS. 3-17, sample screen shots from one embodiment of the GUI 38 are illustrated and will be used to describe operation of the system. It should be noted that the system 10 may be implemented in a manner different from that illustrated in the sample screen shots. FIGS. 3-14 illustrate sample screen shots for an employee who is a teacher.

With specific reference to FIG. 3, the GUI 38 is accessed through a uniform resource locator address or URL which is entered into a web browser. Access of the URL displays a Logon Screen 70. The Logon Screen 70 includes a District ID text box 72, a Login Name text box 74, a Password text box 76, and a GO button 78. from an embodiment of the present invention. The system 10 in the illustrated embodiment is adapted for use with a multi-district organization. Thus to enter the system, the employee 36 enters a district identification, an (assigned) Login Name, and their Password in the appropriate text box 72, 74, 76 and actuates the GO button 78.

In addition, the Logon Screen 70 includes a Need a Tutorial link 80 and a Forget Your Password link 82. The Need a Tutorial link 80 navigates to a tutorial (not shown). The Forget Your Password link 82 navigates to a screen which allows the employee to have their password emailed to the email address.

Once the employee 36 has successfully entered their login ID and password, a News Bulletin Board screen 84 is displayed (see FIG. 4). The News Bulletin Board screen 84 includes a news section 86 where news items, recent events or notices may be posted. For example, reminders regarding holidays, meetings, new course offerings or cancellations, or new requirements, etc. . . . , may be posted. Typically only certain employees 36, such as administrators, have authority to post news items.

The News Bulletin Board screen 84 also includes an Enter Your Learning Path link 88.

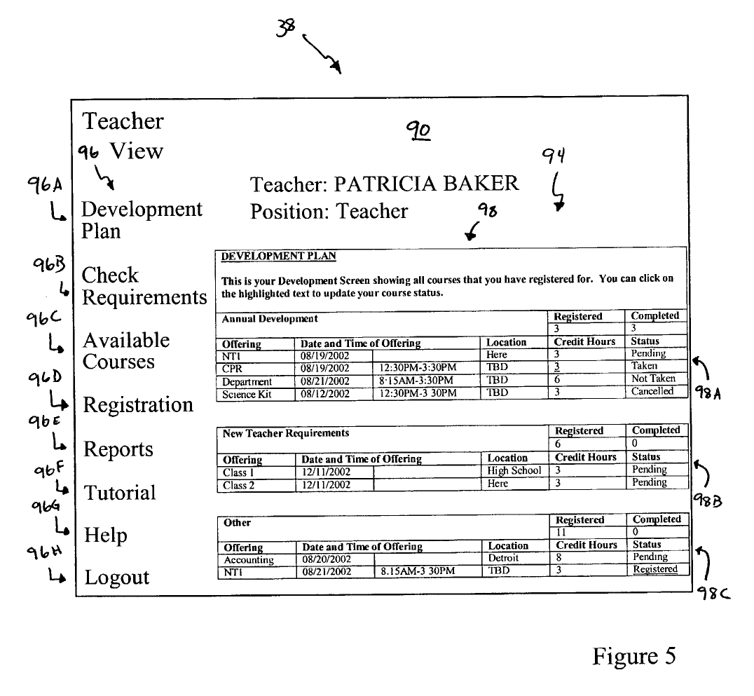

With reference to FIG. 5, selection of the Enter Your Learning Path link 88 navigates to a Development Plan screen 90. The Development Plan screen 90, allows the employee to view and manage their own development plan. The Development Plan screen 90 includes an Employee Identification area 92 which identifies the employee by name and category, e.g., teacher. The Development Plan screen 90 also includes a work area 94 and a list of links 96. The work area 94 displays information related to the employee's development plan. The list of links 96 includes a number of links which assist the employee 36 in navigating the system 10 and managing their development plan. In the illustrated embodiment, the list of links 96 includes a Development Plan link 96A, a Check Requirements link 96B, an Available Courses link 96C, a Registration link 96D, a Reports link 96E, a Tutorial link 96F, a Help link 96G, and a Logout link 96H.

Operation of the Development Plan link 96A, the Check Requirements link 96B, the Available Courses link 96C, the Registration link 96D, and the Reports link 96E will be discussed in detail below. Selection of the Tutorial link 96F navigates to a tutorial for the system 10. Selection of the Help link 96G, navigates to one or more Help screens (not shown) for the system 10. Selection of the Logout link 96H logs the employee 36 out of the system 10.

When the employee 36 first select the Enter Your Learning Path link 88 or selects the Development Plan link 96A, a development screen panel 98 is displayed in the word area 94. The development screen panel 98 includes a list of the courses which the employee 36 has taken or registered to meet their governmental requirements. The first time the employee 36 logs into the system 10, their development plan may be empty or may include some courses for which they have been pre-registered. The plan may also include any carry over credit hours from previous years, if applicable.

In the illustrated embodiment, the employee's development plan has three category of requirements: Annual Development, New Teacher Requirements, and Other. Annual Development requirements refer to requirements which all employees of the same category must meet, e.g., continuing educational requirements. New Teacher requirements are requirements which only new teachers must meet. Other Requirements may include requirement set up by the organization or regulatory authority and may be required for all employees, a subset of employees, or just the current employee. The development screen panel 98 includes an Annual Development section 98A, a New Teachers Requirements section 98B, and an Other section 98C. Each section 98A, 98B, 98C provides details regarding the courses taken or registered by the employee 36 in each category (including name or offering, the date and time, and location, credit hours, and status), as well as the number of credits registered in each category and the number of credits completed in each category.

In one embodiment, each course may have a status of pending, denied, taken, not taken, cancelled, or registered. A course that is pending refers to a special course that the employee 36 has requested (see below). A status of denied refers to a special course request that has been denied. A cancelled course is a course for which the employee had previously registered, but that has since been cancelled.

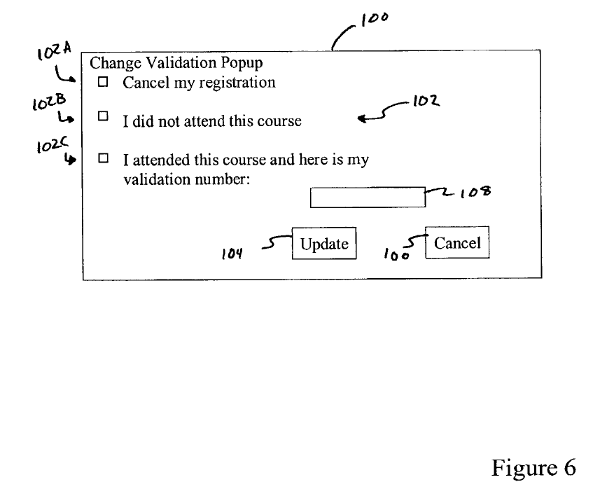

A portion of the listing for each course, e.g., the status, may be linked to allow the employee 36 to update. For example with reference to FIG. 6, selection of the a linked status displays a Change Validation popup 100. The Change Validation popup 100 includes a plurality of options 102 which may include a Cancel my registration option 102A, a I did not attend this course option 102B, and a I attended this course option 102C. The Change Validation popup 100 also includes an update button 104 and a cancel button 106. To update the status of a course on their development plan, the employee 36 checks the appropriate box corresponding to the option and actuates the update button 104. Additionally, the course title may be linked if the course is web-based or may provide a link to allow the employee 36 to change the requirement to which the course is being applied.

Attendance or completion of a course may be accomplished using a plurality of methods. For example, the employee 36 may be allowed to indicate attendance by indicating using the Change Validation popup 100. Alternatively, the Change Validation popup 100 may require that the employee 36 input a validation number into a validation number text entry box 108, which was given to the employee 36 by the instructor of the course. Alternatively, completion or attendance may be validated by the instructor or some other means.

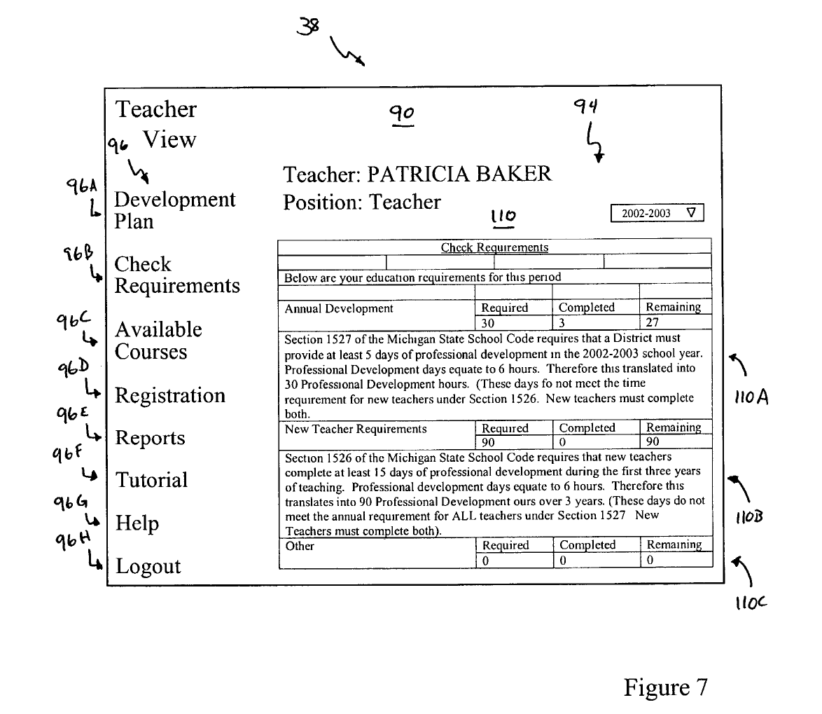

With reference to FIG. 7, selection of the Check Requirements link 96B, displays a Check Requirements panel 110 in the work area 94. The Check Requirements panel 110 displays information relating to the employee's 36B status in each category of requirements. In the illustrated embodiment, the employee's requirements are categorized as Annual Development requirements, New Teacher requirements, and Other requirements. Details for each category are displayed in an Annual Development section 110A, a New Teacher requirements section 110B, and an Other requirements section 110C, respectively. Each category is detailed with the number of credit hours required, the number of credit hours completed, and the number of credit hours remaining (that must be completed by the employee 36). Additionally, other descriptive text may be supplied, as shown.

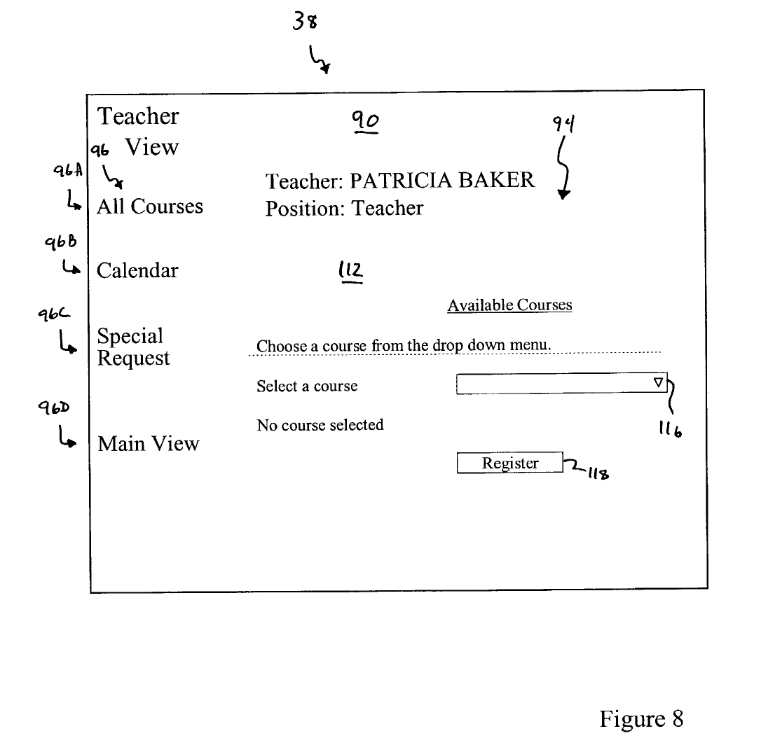

With reference to FIG. 8, selection of the Available Courses link 96C displays an Available Courses panel 112 in the work area 94. Additionally, a list of course links 114 are displayed. In the illustrated embodiment, the list of course links 114 include an All Courses link 114A, a Calendar link 114B, a Special Request link 114C, and a Main View link 114D. Actuation of the Main View link 114D, navigates back to the development plan view (see above).

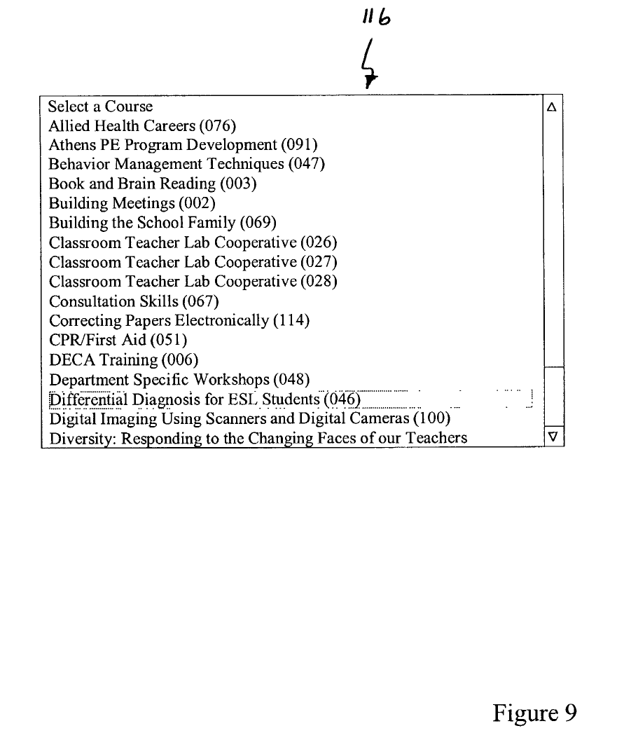

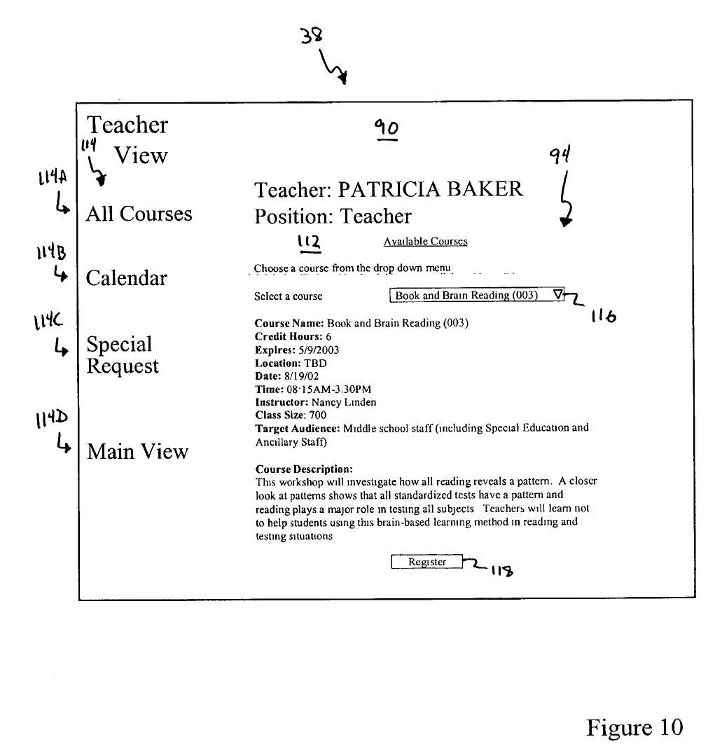

When the Available Courses link 96C or the All Courses link 114A the Available Courses panel 112 is displayed. The Available Courses panel 112 includes an Available Courses drop down list 116 and a Register button 118. With reference to FIG. 9, expansion of the Available Courses drop down list 116 allows the employee 36 to select an available course from a scrollable list. With reference to FIG. 10, selection of an available course in the Available Courses drop down list 116, displays information related to the selected course, including for example, name, credit hours, location, date, time, instructor, class size, target audience, and a course description. Actuation of the Register button 118 registers the employee 36 for the course. When the employee 36 is registered for a course, their data in the database 22 and their employee development plan is updated. Navigation back to the Development Plan screen 90 will display the updated plan.

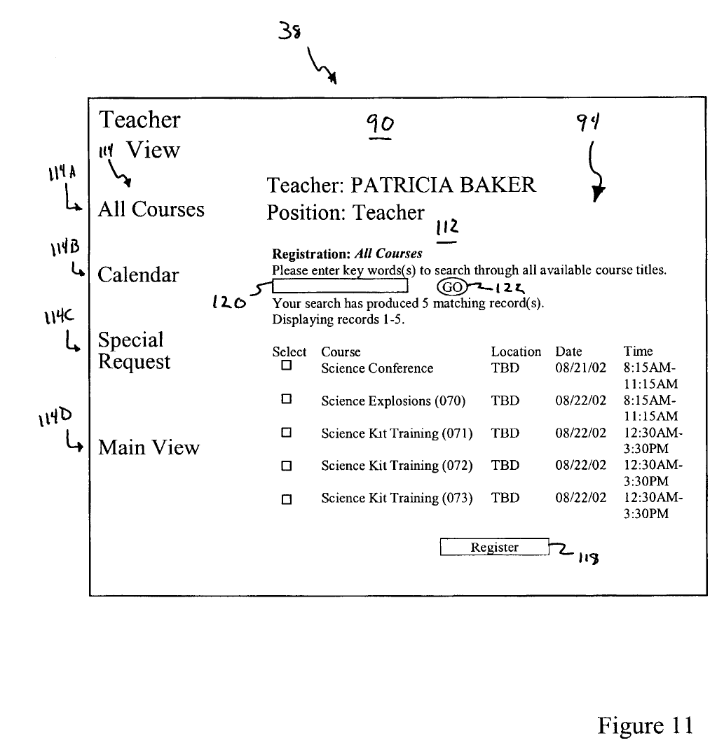

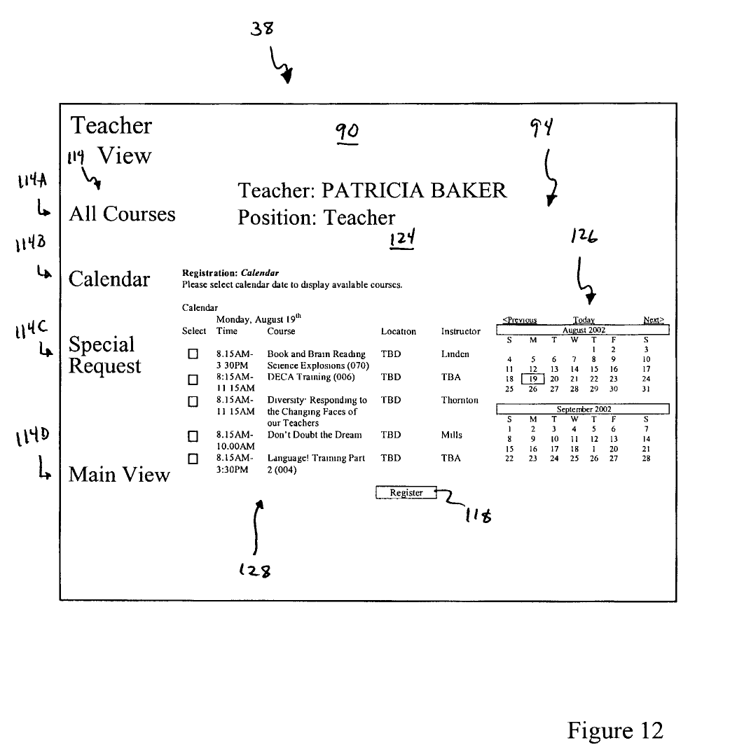

With reference to FIGS. 11 and 12, the employee 36 may search and register for courses using additional methods. With reference to FIG. 11, the employee 36 may search for available courses by entering a key word or words in a search box 120 and actuation a GO button 122. Courses containing the entered key word(s) are displayed in the Available Courses panel 112. The employee 36 may select one or more of the listed courses and register by actuating the Register button 118.

Selection of the Calendar link 114B, displays an Available Courses—Calendar panel 124. The Available Courses—Calendar panel 124 includes a calendar 126 which is the employee 36 may scroll forward and back. Selection of a day on the calendar 126, displays a list 128 of the courses available on the selected day. The employee 36 may select one or more of the listed courses and register by actuating the Register button 118.

Selection of the Special Request link 114C, displays a Special Request panel 130 which allows the employee 36 to request a course that is not currently listed as available. For example, the employee 36 may request a course that is being offered at a local college. The Special Request panel 130 includes a form 132 in which the employee 36 provides detail about the requested course.

Once the form 132 is filled out, the employee 36 actuates a Submit button 132 to submit the request. In one aspect of the present invention, the request is transferred to another employee, such as an administrator or a principal or other designated employee, who reviews the request and approves or denies the request.

In one embodiment, the employee who reviews the request receives an email with the request.

In another embodiment, the request may be displayed to the designated employee when they log onto the system 10. Additionally, an email may be sent to the designated employee when they have a request (or a certain number of requests) which must reviewed.

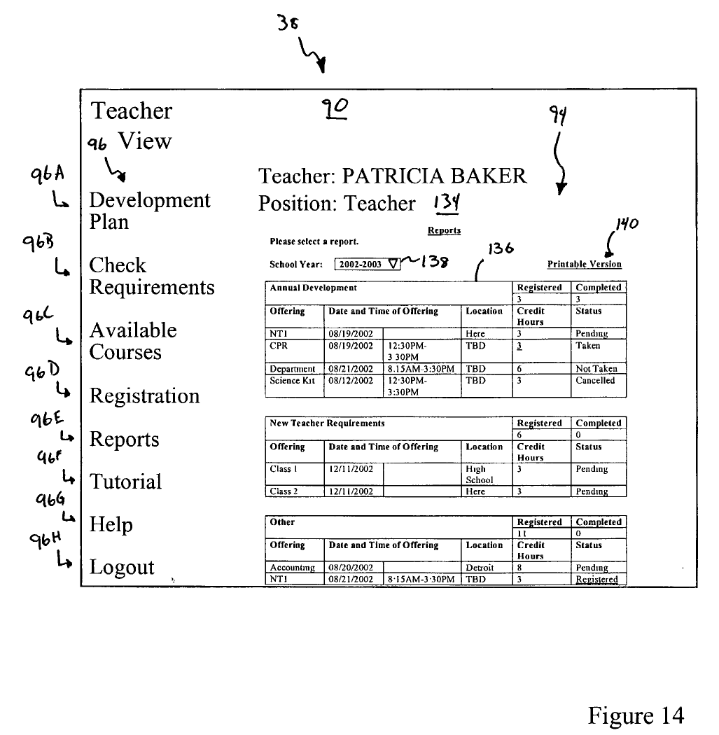

With reference to FIG. 14, selection of the Reports link 96E displays a Reports panel 134. The Reports panel 134 displays a report 136 which includes details regarding the employee's development plan. The Reports panel 134 also includes a School Year drop down list 138 which allows the employee 36 to choose the school year for which a report is generated. Selection of a Printable Version link 140, displays a version of the report which is formatted for printing.

As discussed above, the features of the system 10 available to the employee 36 may vary depending on their category of employee. For example, a teacher may be able to view their requirements and their development plan. An administrator may be able to view their requirements and their development plan. Additionally, the administrator may have access to other portions of the system 10 as a result of their responsibilities, e.g., reviewing special course requests (see above), review the development plan of other employees and/or adding, modifying or removing courses from the list of available courses.

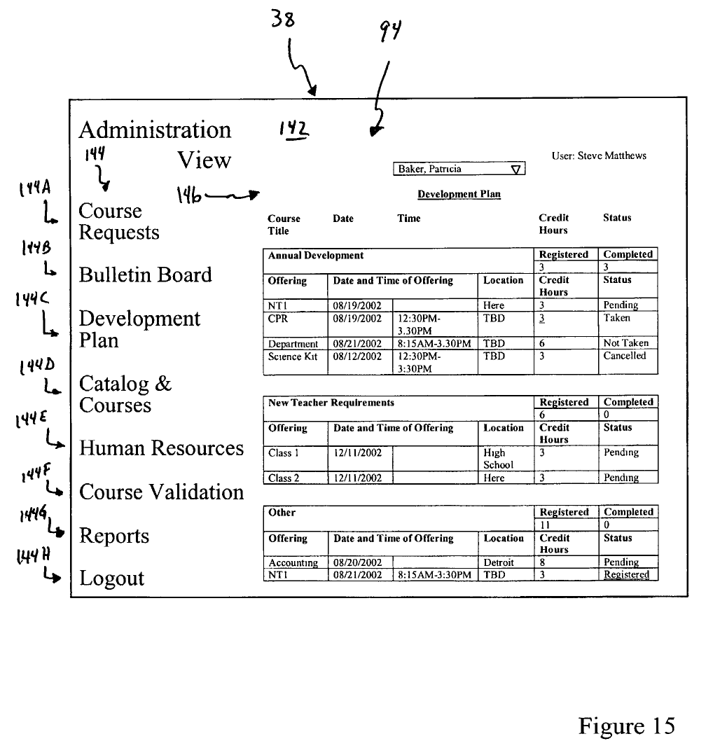

With reference to FIG. 15, if an administrator 36 logins into the system 10, an Administration View screen 142 may be displayed in the GUI 38. The Administrative View screen 142 includes a list of administration links 144. In the illustrated embodiment, the list of administration links 144 includes a Course Requests link 144A, a Bulletin Board link 144B, a Development Plan link 144C, a Catalog and Courses link 144D, a Human Resources link 144E, a Course Validation link 144F, a Reports link 144G, and a Logout link 144H.

Selection of the Course Requests link 144A navigates to a screen (not shown) which allows the administrator to review and approve or deny received course special requests (see above).

Selection of the Bulletin Board link 114B navigates to a screen (not shown) which allows the administrator to add, modify, or delete items on the bulleting board.

Selection of the Human Resources link 114E navigates to a screen (not shown) which allows the administrator access to human resources related functions.

Selection of the Reports link 114G navigates to a screen (not shown) which allows the administrator to prepare and print out reports of the development plans of the employees.

Selection of the Logout link 114H logs the administrator out of the system 10.

Selection of the Development Plan link 144C, displays an Administrator Development Plan panel 146 in the work area 94. The Administrator Development Plan panel 146 includes an Employee drop down list 148 and a Plan section 150. The Employee drop down list 148 includes all of the employees for which the administrator has access (which may be all or less than the employees in the organization). The administrator selects an employee in the Employee drop down list 148 and that employee's development plan is displayed in the Administrator Development Plan panel 146.

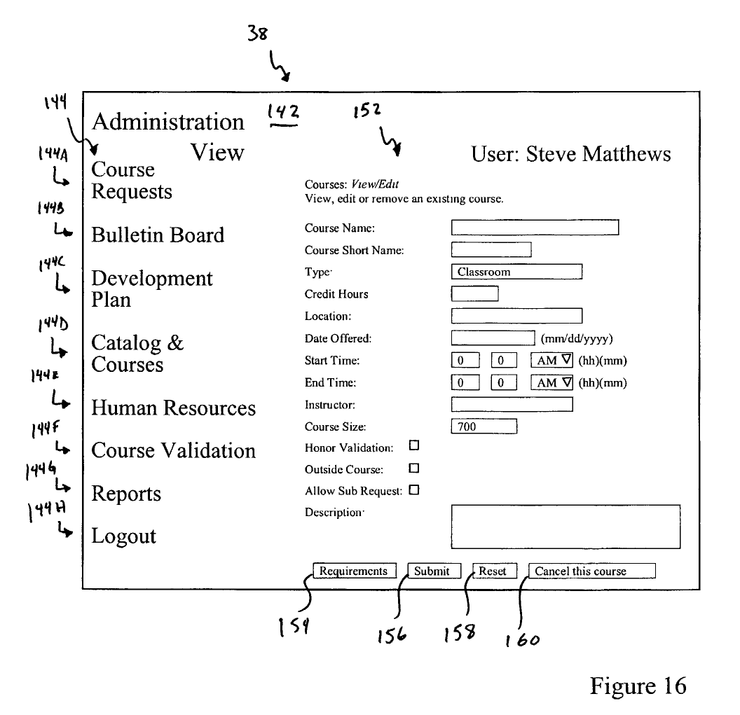

Selection of the Catalog & Courses link 144D allows the administrator to review, modify, cancel or add courses to the list of available courses. With specific reference to FIG. 16, a View/Edit panel 152 allows the administrator to review and modify the existing information for a course and add a new course. The View/Edit panel 152 includes a Requirements button 154, a Submit button 156, a Reset button 158, and a Cancel this course button 160.

Selection of the Submit button 156 updates the database 22 with the modified course data or the new course. Selection of the Reset button 158 clears the data in the View/Edit panel 152. Selection of the Cancel this course button 160 removes the course from the list of available courses.

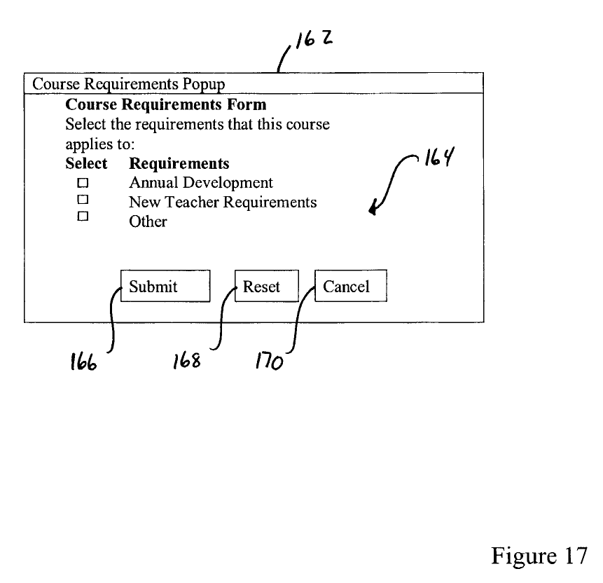

With reference to FIG. 17, selection of the Requirements button 154 displays a Course Requirements popup 162. The Course Requirements popup 162 allows the administrator to select the requirements to which the course applies. For example, the course may be used to meet the annual development requirements, the new teacher development requirements, the other requirements, or any combination thereof.

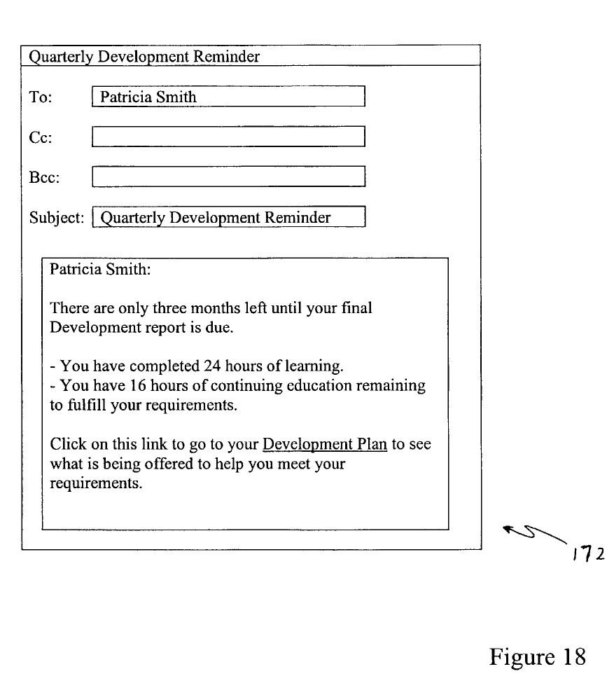

As discussed above, email communications may be used to automatically alert users in a timely manner about specific events. For example, in FIG. 18, a sample email communication 172 is shown. The sample email communication 172 provides a reminder to the targeted user, Patricia Smith, that she has only three month until her final development report is due. The email communication 172 may also give additional, related information, such as the number of completed hours and the number of remaining hours. Also, the email communication 172 may provide a link, as shown, to the user's development plan.

The above description of the sample screen shots illustrate a system which has been adapted for use with an educational organization and has been described with respect to teachers and an administrator. However, it should be recognized that variations of the screen shots are possible without departing from the invention. Furthermore, the GUI may be dynamic in that the contents of each screen may vary as a function of the individual employee, the category of the employee, the particular government and organization requirements, and/or the size and structure of the organization.

Other aspects, object, and features of the present invention may be obtained from a study of the drawings, the disclosure, and the appended claims. Obviously, many modifications and variations of the present invention are possible in light of the above teachings. Furthermore, the invention may be practiced otherwise than as specifically described within the scope of the appended claims.

What is claimed is:

1. A computer based system for managing and tracking development of employees for an organization, comprising:
a database for storing employee development and government requirements data relating to the development of the employees; and,
a first processing unit, coupled to the database, for providing access to the data to the employees and for allowing an employee to manage an employee development plan as a function of the data and sign up for courses to meet the government requirements, the processing unit being adapted for verifying the completion of a course by the employee and for responsively updating the employee development data.

2. A system, as set forth in claim 1, wherein the first processing unit is adapted to send communications employees related to their development plan.

3. A system, as set forth in claim 2, wherein the communications are sent via email.

4. A system, as set forth in claim 2, wherein the communications includes confirmation regarding one of a registration, cancellation or completion of a course.

5. A system, as set forth in claim 2, wherein the communications includes periodic reminders to employees to update their development plans.

6. A system, as set forth in claim 1, further including a second processing unit coupled to the first processing unit, wherein the employee accesses the computer based system through the second processing unit.

7. A system, as set forth in claim 6, where the first and second processing units are implemented in first and second computers, respectively.

8. A system, as set forth in claim 7, wherein the first and second computers are coupled by a computer network.

9. A computer system, as set forth in claim 7, wherein the first and second computers are coupled via the internet.

10. A system, as set forth in claim 1, wherein the organization is an educational organization.

11. A system, as set forth in claim 7, wherein the employees are one of a teacher, an administrator, and a staff employee.

12. A system, as set forth in claim 1, wherein the organization includes a plurality of school districts.

13. A system, as set forth in claim 1, wherein the organization includes a plurality of states, each state including a plurality of school districts.

14. A system, as set forth in claim 6, further comprising a graphical user interface, implemented on the second computer, for providing access to the system to the employees.

15. A system, as set forth in claim 14, wherein the graphical user interface includes a news section.

16. A system, as set forth in claim 14, wherein the graphical user interface includes a professional development plan section for displaying the status of the employee development plan.

17. A system, as set forth in claim 16, wherein the professional development plan includes at least one course and a status corresponding to the at least one course.

18. A system, as set forth in claim 17, wherein the status is one of taken, pending, not taken, cancelled, registered.

19. A system, as set forth in claim 14, wherein the processing unit verifies completion of a course through a validation pop-up dialog.

20. A system, as set forth in claim 14, wherein the user interface is adapted to display available courses to the employee.

21. A system, as set forth in claim 14, wherein the user interface is adapted to allow the employee to register for courses.

22. A system, as set forth in claim 14, wherein the user interface is adapted to allow the employee to request a special course.

23. A system, as set forth in claim 14, wherein the user interface is adapted to allow an administrator to edit or add courses.

24. A system, as set forth in claim 1, wherein the first processing unit is adapted to provide news related to the organization or development plan to the employee.

25. A system, as set forth in claim 1, wherein the processing unit is adapted to display to the employee the status of the employee development plan.

26. A system, as set forth in claim 25, wherein the professional development plan includes at least one course and a status corresponding to each course.

27. A system, as set forth in claim 26, wherein the status is one of taken, pending, not taken, cancelled, registered.

28. A system, as set forth in claim 1, wherein the processing unit verifies completion of a course through a validation by the employee.

29. A system, as set forth in claim 1, wherein the processing unit is adapted to allow the employee to register for courses.

30. A system, as set forth in claim 1, wherein the processing unit is adapted to allow the employee to request a special course.

31. A system, as set forth in claim 1, wherein the processing unit is adapted to allow an administrator to edit and/or add courses.

32. A computer based system for managing and tracking development of employees for an education organization, comprising:
a database for storing employee development and government requirements data relating to the development of the employees; and,
a first processing unit, coupled to the database, for accessing to the data; and,
a second processing unit coupled to the first processing unit, for providing access to the system to the employees and for allowing an employee to manage an employee development plan as a function of the data and sign up for courses to meet the government requirements, the processing unit being adapted for verifying the employees completion of courses and for responsively updating the employee development data.

33. A system, as set forth in claim 32 where the first and second processing units are implemented in first and second computers, respectively.

34. A system, as set forth in claim 33, wherein the first and second computers are coupled by a computer network.

35. A computer system, as set forth in claim 33, wherein the first and second computers are coupled via the internet.

36. A system, as set forth in claim 32, wherein the employees are one of a teacher, an administrator, and a staff employee.

37. A system, as set forth in claim 32, wherein the educational organization includes a plurality of school districts.

38. A system, as set forth in claim 32, wherein the organization includes a plurality of states, each state including a plurality of school districts.

39. A computer based method for managing and tracking development of employees for an organization, comprising:
storing employee development and government requirements data relating to the development of the employees in a database; and,
providing access to the data to the employees;
allowing an employee to manage an employee development plan as a function of the employee development and the government requirements data and to sign up for courses to meet the government requirements; and,
verifying completion of a course by the employee and for responsively updating the employee development data.

40. A method, as set forth in claim 39, wherein the organization is an educational organization.

41. A method, as set forth in claim 40, wherein the employees are one of a teacher, an administrator, and a staff employee.

42. A method, as set forth in claim 39, wherein the organization includes a plurality of school districts.

43. A method, as set forth in claim 39, wherein the organization includes a plurality of states, each state including a plurality of school districts.

44. A method, as set forth in claim 39, including providing news to the employee related to the organization or development plan.

45. A method, as set forth in claim 39, including displaying to the employee the status of the employee development plan.

46. A method, as set forth in claim 45, wherein the professional development plan includes at least one course and a status corresponding to each course.

47. A method, as set forth in claim 46, wherein the status is one of taken, pending, not taken, cancelled, registered.

48. A method, as set forth in claim 39, wherein the verification of completion of a course is accomplished through a validation by the employee.

49. A method, as set forth in claim 39, including the step of allowing an employee to register for courses.

50. A method, as set forth in claim 39, including the step of sending communications employees related to their development plan.

51. A method, as set forth in claim 50, wherein the communications are sent via email.

52. A method, as set forth in claim 50, wherein the communications includes confirmation regarding one of a registration, cancellation or completion of a course.

53. A method, as set forth in claim 50, wherein the communications includes periodic reminders to employees to update their development plans.
